(19) United States
(12) Patent Application Publication
(10) Pub. No.: US 2011/0167067 A1
(43) Pub. Date: Jul. 7, 2011

(54) CLASSIFICATION OF APPLICATION COMMANDS

(76) Inventor: Kishore Kumar MUPPIRALA, Bangalore (IN)

(21) Appl. No.: 12/851,558

(22) Filed: Aug. 6, 2010

(30) Foreign Application Priority Data
Jan. 6, 2010 (IN) 28/DEL/2010

(51) Int. Cl. G06F 15/16; G06F 17/30; G06F 15/173; G06F 9/46

(52) U.S. Cl. 707/740; 709/201; 709/226; 718/103; 707/E17.089

(57) ABSTRACT

Methods for classification of application commands are described. An application command associated with a classification parameter is generated by an application in a first device. A classification value is determined for the application command based on the classification parameter. The classification value is associated with the application command and is sent to a second device for processing.

### BACKGROUND

In the context of a network environment, QoS can be considered to be the capability of a network to manage and provide access of resources, for example by allocation of a traffic capacity, or providing an access to a storage capacity, or an access to another application, based on the desired priorities requested by any of the devices connected to the network. The QoS is typically delivered over various technologies such as Asynchronous Transfer Mode (ATM), Ethernet and IEEE 802.1 networks, IP-routed networks, etc., in a network environment for resource access in the network environment. In an example, QoS may be required when an application generates a command, such as a storage request, a network resource request, or a processing resource request

Generally, multiple applications running over dispersed host devices issue such service commands to one or more target devices. For example, in a typical storage area network (SAN) implementation, multiple host devices use several service commands, such as input/output (I/O) commands, to store and retrieve data from the target devices, for example data storage devices, disk drives and disk array. In such a case, the application commands received from the hosts are prioritized at the target device in the SAN to provide an expected quality of service (QoS).

Classification of the incoming commands at a target device is generally based on a logical unit number (LUN) of the target device for a target-level QoS. Similarly, in cases where multiple operating systems (OSs) are running on the same host, such as in virtual systems, the classification of the application commands from guest OSs is based on virtual ports created for each of the guest OSs. A virtual port facilitates communication of a device with other devices in the network through, typically, a single physical port on the host system. Therefore, the classification of the commands is based on the virtual port from which the command is sent or the LUN, irrespective of the source of the application command. Hence, even a non-application command, for example, an OS kernel command, can be assigned a priority similar to that of an application command.

### BRIEF DESCRIPTION OF THE DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a network environment 100 for implementing classification of application commands in accordance with an embodiment of the present invention.

FIG. 2 illustrates a network environment 200 for implementing classification of application commands in accordance with another embodiment of the present invention.

FIG. 3 illustrates an exemplary host device for classification of an application command in accordance with an embodiment of the present invention.

FIG. 4(a) illustrates exemplary OS-mapping tables for classification of application commands in accordance with one embodiment of the present invention.

FIG. 4(b) illustrates exemplary H-mapping tables for classification of application commands in a virtual environment in accordance with one embodiment of the present invention.

FIG. 5 illustrates an exemplary method for the classification of application commands, according to an embodiment of the present invention.

### DETAILED DESCRIPTION

Systems and methods for classification of an application command are described herein. More particularly, the systems and methods provide an application-based QoS by classifying application commands. These systems and methods can be implemented in a variety of operating systems, such as MS Windows, HP-UX, and Linux, and also in a virtual machine (VM) environment implemented using a variety of system architectures, for example, Hyper-V architectures, Multi-Core architectures, and the like. Devices that can implement the described methods include a diversity of computing devices, such as a server, a desktop PC, a notebook or portable computer, a workstation, a mainframe computer, a mobile computing device, and an entertainment device.

In the described methods, a classification value is associated with an application command within a host for prioritizing the application command at the target device. Such a method is effective in delivering an application-level QoS in various network environments. For example, the method may be used for prioritizing application input output (I/O) commands to deliver QoS in a storage area network (SAN) environment. In other cases, the method may be used to deliver QoS to applications competing for shared network resources or processing resources in a network environment, such as access or allocation of bandwidth in the network. The method can also be used to monitor and optimize application performance for different user requirements.

### Exemplary Network

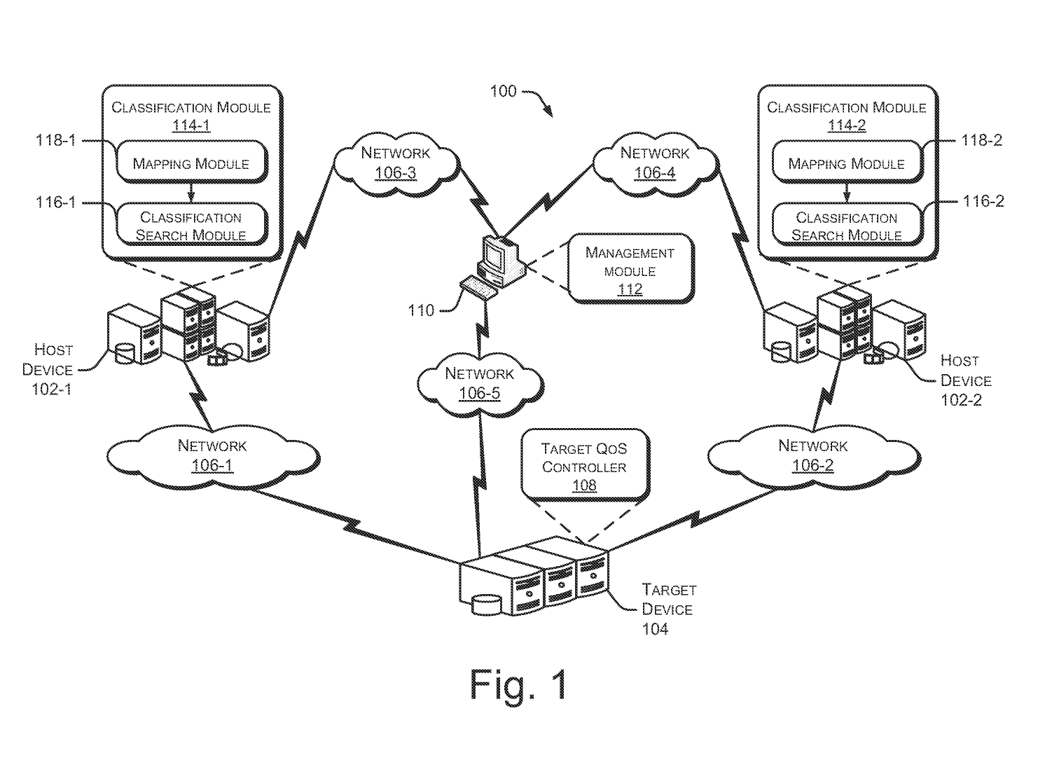

FIG. 1 illustrates a network environment 100 for implementing classification of application input/output commands in accordance with an embodiment of the present invention. The concepts described herein can be applied to classify application commands in any network environment having a variety of network devices such as routers, bridges, computing devices, storage devices, and servers. For example, the network environment 100 may be a storage area network (SAN).

The network environment 100 includes a plurality of host devices such as host devices 102-1 and 102-2 communicating with a target device 104 via networks 106-1, 106-2, 106-3, 106-4, and 106-5, hereinafter collectively referred to as networks 106. The host devices 102-1 and 102-2, hereinafter collectively referred to as host devices 102, may also interact with each other. The host device 102-1 may be any networked computing device, for example, a personal computer, a workstation, a server, etc., that hosts various applications and can provide service to and request service from other devices connected to the networks 106-1 and 106-2. Generally, a host device, for example, the host device 102-1, includes one or more applications, one or more operating systems, and one or more physical interfaces. Further, each of the host devices 102 includes a host QoS controller (not shown in the figure) to manage sending and receiving of various application commands, such as data read requests and data write requests.

The networks 106 may be wireless or wired networks, or a combination thereof. The networks 106 can be a collection of individual networks, interconnected with each other and functioning as a single large network, for example the Internet or an intranet. Examples of such individual networks include, but are not limited to, Storage Area Networks (SANs), Local Area Networks (LANs), Wide Area Networks (WANs), and Metropolitan Area Networks (MANs). The networks 106 may also include network devices such as hubs, switches, routers, and so on.

In an implementation, the target device 104 may be a computing device that has data storage capability and provides service to the host devices 102. Examples of the target device 104 include, but are not limited to, workstations, network servers, storage servers, block storage devices, other hosts and so on. In another implementation, the target device 104 may be a network device, such as a router or a bridge that can manage network traffic, for example by allocating bandwidth. Generally, the target device 104 includes a target QoS controller 108 to manage processing of various application commands, such as data read requests, data write requests, and maintenance requests, received from the hosts 102.

The network environment 100 further includes a hardware interface console 110, hereinafter referred to as console 110, which may include a personal computer, a workstation, or a laptop. In an implementation, the console 110 can include a management module 112 that facilitates centralized management of network QoS. In another implementation, the management module 112 can also be installed on a host device, such as host device 102-1 or 102-2. The management module 112 is configured for providing and monitoring QoS to manage, adjust, and optimize performance characteristics, such as system and network bandwidth, jitter, and latency of the networks 106. The management module 112 provides a user interface to facilitate user-defined modifications of QoS level descriptors including I/O usage parameters, bandwidth parameters, sequential access indicators, etc., for achieving a desired level of QoS.

In an implementation, an application-A (not shown in the figure) executed in the host device 102-1 may generate an application command, hereinafter referred to as a first application command, to request a data read from the target device 104. Similarly, an application-B (not shown in the figure) executed in the host device 102-2 may also generate an application command, hereinafter referred to as a second application command, which also requests for a data read and competes with the first application command for resources at the target device 104. In order to provide a desired QoS at the target device 104 to the first and the second application commands, the commands can be classified with the help of QoS level descriptors. The QoS level descriptors, such as service level information and precedence bits, can be used by the target device 104 to deliver a requested service at the desired QoS.

The service level information corresponds to basic end-to-end QoS delivering approaches such as best-effort service, differentiated service, also called as soft QoS, and guaranteed service, also called as hard QoS. Typically, an application is pre-programmed to define a particular service level in the application commands based on latency, throughput, and possibly reliability expected for the application commands. The precedence bits are generally left blank and are set at the target device 104 to deliver the required QoS. The precedence bits are set based on parameters such as logical unit number (LUN) of a disk on the target device 104 and IP addresses of the hosts 102. Therefore, typically, a target-level QoS is delivered rather than a stipulated QoS based on applications, for example, the application-A and the application-B, which generate the application commands such as I/O commands.

To deliver an application based QoS, in an embodiment, the host devices 102-1 and 102-2 include respective classification modules 114-1 and 114-2, hereinafter collectively referred to as classification modules 114, which provide a classification value to each of the application commands. The classification value acts as the QoS level descriptor to provide classification information and is used to classify the commands based on classification parameters associated with the commands. The classification value can be, for example, a tag value or a virtual port number such as a V-port or an NPIV number, or both. The classification value can be used to classify the application commands both inside the host devices 102 and outside the host devices 102 over the networks 106.

For the purpose, in said embodiment, the classification module 114-1 includes a classification search module 116-1 and a mapping module 118-1, and the classification module 114-2 includes a classification search module 116-2 and a mapping module 118-2. The classification search modules 116-1 and 116-2, collectively referred to as classification search modules 116, search for classification values from respective mapping tables, which are maintained by their respective mapping modules 118-1 and 118-2, hereinafter collectively referred to as mapping modules 118. The respective classification values determined from the mapping tables provided by the mapping modules 118 are inserted in the first and the second application commands at the host devices 102. Association of the classification values with the application commands at the host devices 102 thus facilitates attaching application-based classification information with the application commands. These application commands are then sent to the target device 104 for prioritization and processing of the commands based on the classification values for realizing desired QoS.

In an embodiment, the mapping module 118-1 is located in the host QoS controller of the host device 102-1 and the mapping module 118-2 is located in the host QoS controller of the host device 102-2. The mapping modules 118 dynamically maintain and update the mapping tables with classification values corresponding to one or more parameters associated with the application commands. These mapping tables are maintained and updated based on interactions of the mapping modules 118 with the management module 112. Based on the user-defined QoS policies delineated at the management module 112, the management module 112 is configured to provide classification values to the mapping modules 118.

In an implementation, the host QoS controllers are unaware of the existence of the target QoS controller 108 in the networks 106 though the host devices 102 are aware of the connected devices such as the target device 104. The management module 112 interacts with the host QoS controllers associated with the host devices 102 and a target QoS controller 108 associated with each of the target device 104 through the networks 106-3, 106-4, and 106-5 to deliver centralized QoS management. Accordingly, the management module 112 communicates information related to assignment and handling of classification values associated with the application commands to the target QoS controller 108 and to the mapping modules 118 in the host QoS controller. Thus, when the target device 104 receives a classified application command from any of the host devices 102, the target device 104 can prioritize the classification application commands based on priority mapping tables received from the target QoS controller 108 to provide an expected level of QoS.

It will be understood that the network environment 100 can include a number of host devices communicating with one or more target devices through various networks and will operate in a similar manner as described herein.

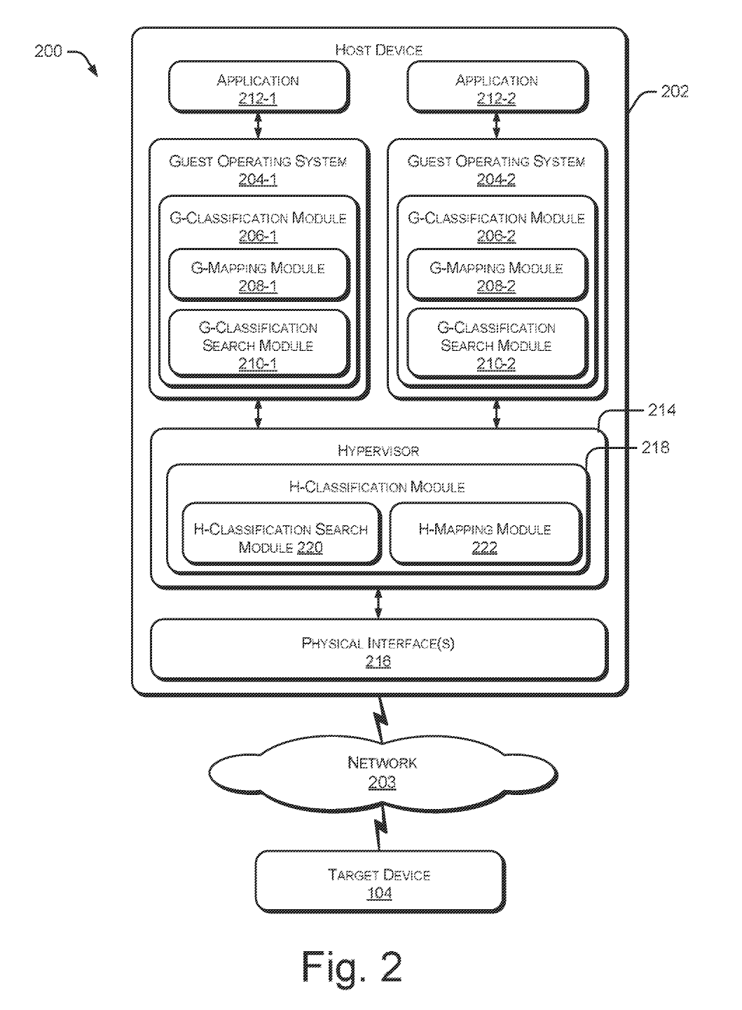

FIG. 2 illustrates a network environment 200 for classification of the application commands in a virtual environment, according to another embodiment of the present invention. The network environment 200 includes a host device 202 communicating with the target device 104 via a network 203. The network 203 may be similar to any of the networks 106. In one implementation, the host device 202 can be configured to operate as a virtual machine running multiple operating systems, hereinafter referred to as guest operating systems. For example, the host device 202 includes a first guest operating system (OS) 204-1 and a second guest OS 204-2.

In said embodiment, the first guest OS 204-1 includes a G-classification module 206-1 having a G-mapping module 208-1 and a G-classification search module 210-1. The first guest OS 204-1 can have one or more associated applications, for example, the application 212-1. Similarly, the second guest OS 204-2 may include a G-classification module 206-2 having a G-mapping module 208-2 and a G-classification search module 210-2. The second guest OS 204-2 can have one or more associated applications, for example, application 212-2. The first and the second guest operating systems 204-1 and 204-2, hereinafter collectively referred to as guest operating systems 204, interact with a virtual machine monitor, referred to as hypervisor 214, to access physical interfaces 216 on the host device 202.

A hypervisor, such as the hypervisor 214, provides for virtualization of a software platform, i.e., application virtualization, or virtualization of a hardware platform, i.e., a computer system, which allows multiple operating systems to run on a host device concurrently. The hypervisor 214 can be implemented in different architectures, for example, bare-metal architecture or hosted architecture, already known in the art. The hypervisor 214 is responsible for creating, managing, and destroying virtual ports, which are either mapped to or provided by physical interface 216, dedicated to route the application commands from each of the guest operating systems 204 running on the physical host device 202. The hypervisor 214 directly controls access to processor resource and enforces an externally delivered policy on memory and physical device access.

At the hypervisor 214, application commands, such as I/O commands received from the applications 212 via the guest operating systems 204, are processed and dispatched to the target device 104, through a physical interface, such as one of the physical interfaces 216. The physical interfaces 216 correspond to interface devices, such as a host adaptor, used to connect the host device 202 to other network devices through a computer bus. The physical interfaces 216 may be based on different standards for physically connecting and transferring data between the host device 202 and other devices. Examples of such standards include, but are not limited to, small computer system interface (SCSI), internet SCSI (iSCSI), fiber channel, fiber channel over Ethernet (FCoE) and universal serial bus (USB).

In an implementation, a first application command generated by the application 212-1 and a second application command generated by the application 212-2 can be received by the guest operating systems 204-1 and 204-2, respectively. At the guest operating system 204-1, the G-classification module 206-1 interacts with the first application command to provide a classification value with the help of the G-mapping module 208-1 and the G-classification search module 210-1 included in the G-classification module 206-1.

Similarly, the second application command can be provided with a classification value with the help of the G-mapping module 208-2 and the G-classification search module 210-2 included in the G-classification module 206-2. The classification values can be provided based on one or more classification parameters associated with the first application command and the second application command. As discussed, the classification value can be, for example, a tag value or a virtual port number such as a V-port or an NPIV number, or both. The G-classification modules 206 provide the classification values in a manner similar to that of the classification modules 114 explained in the description of FIG. 1.

Each of the first application command and the second application command having a classification value provided by the guest operating systems 204 can be handled by the hypervisor 214 through virtual ports (v-ports), such as N-port ID virtualization (NPIV) ports (not illustrated in the figure). In an embodiment, the first and the second application commands can be handled by the hypervisor 214 in the host device 202. In said embodiment, the hypervisor 214 can be configured to include an H-classification module 218, similar to the G-classification modules 206. Correspondingly, the H-classification module 218 includes an H-classification search module 220 and an H-mapping module 218, which operate similar to the G-classification search modules 210 and the G-mapping modules 208.

In a first implementation, the hypervisor 214 can assign new classification values such as new tag values to the already previously classified first and the second application commands. The new classification values can be assigned to the first and the second application commands based on guest IDs associated with the first guest OS 204-1 and the second guest OS 204-2 by the hypervisor 214. The guest IDs can be assigned to the first guest OS 204-1 and the second guest OS 204-2 using a variety of workload management techniques, for example, process resource manager (PRM) in case of HP-UX OS. These new classification values can be carried by the first and the second application commands on the physical interface 216 to prioritize the commands at the target device 104.

Generally, the hypervisor 214 deploys one or more v-ports to each of the guest operating systems 204. The number of v-ports that are associated with a guest operating system depend upon the number of available physical interfaces 216. In a second implementation, the hypervisor 214 can classify the previously-tagged first and the second application commands based on the v-ports to prioritize the application commands within the host device 202.

In another embodiment, the first and the second application commands may be handled through the v-ports such as NPIV ports. In an implementation, these application commands can be classified based on a NPIV port through which a particular application command, for example, first application command or second application command, are routed to the target device 104. NPIV port numbers act as classification values that can be tagged with the first and the second application commands. These embodiments can use one or more appropriate mapping tables to deploy these implementations. The mapping tables are discussed in detail later.

In an example, the hypervisor 214 can create, update, and store mapping tables, hereinafter referred to as H-mapping tables. Therefore, even in a virtual environment, the application commands can be classified using the classification values through the G-classification modules 206, and the H-classification module 218 without modifying the applications generating the commands. Thus, the classification values associated with the application commands can be used to deliver application-level QoS at the target device 104.

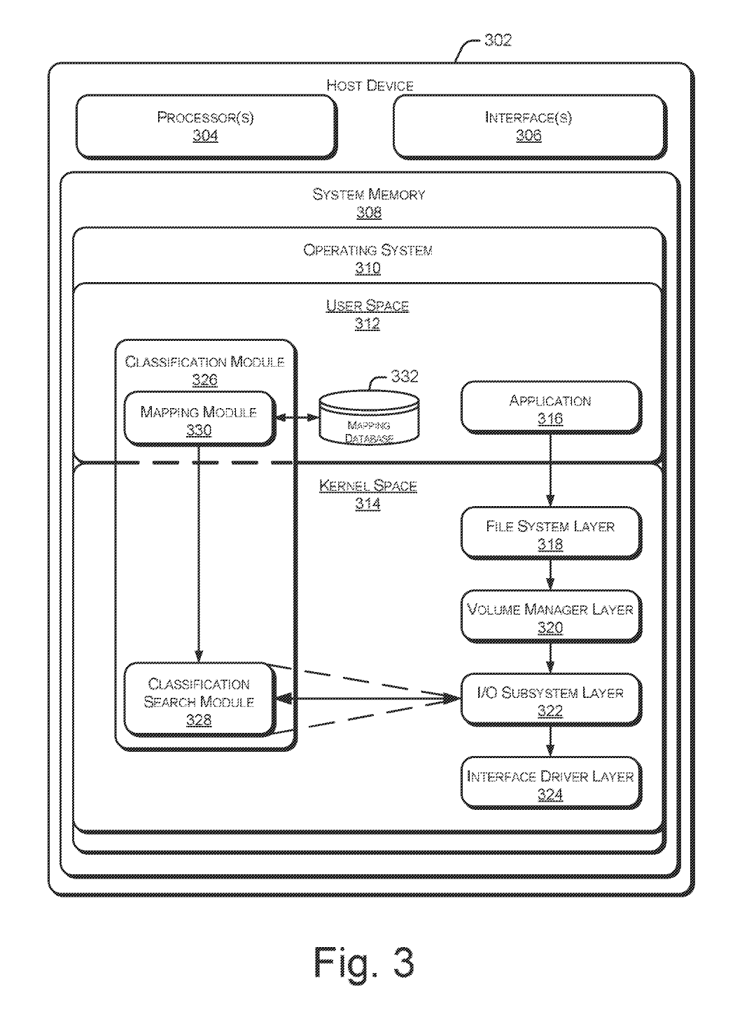

FIG. 3 illustrates an exemplary host device for classification of an application command in accordance with an embodiment of the present invention. The host device 302 includes one or more processor(s) 304, one or more interfaces 306, and a system memory 308. The processor(s) 304 may include, for example, microprocessors, microcomputers, microcontrollers, digital signal processors, central processing units, state machines, logic circuitries, and/or any devices that manipulate signals based on operational instructions. Among other capabilities, the processor(s) 304 are configured to fetch and execute computer-readable instructions stored in the system memory 308.

The interface(s) 306 can include a variety of software interfaces, for example, application programming interfaces, or hardware interfaces, for example, host adaptors, or both to connect to network devices, such as data servers, computing devices, and so on. The interface(s) 306 facilitate receipt of classification values by the host device 302 from the management module 112 and reliable transmission of application commands to a target device, such as target device 104.

The system memory 308 can include any computer-readable medium known in the art including, for example, volatile memory (e.g., RAM) and/or non-volatile memory (e.g., flash memory, phase-change memory, etc.). The system memory 308 can include one or more operating systems, such as an operating system 310. Generally, the operating system 310 has a user space 312 and a kernel space 314. The user space 312 refers to the portion of the operating system 310 in which user processes run. The user processes include system processes, such as logon and session manager processes; server processes, such as event log and scheduler; environment subsystems used to create OS environment for the applications; and user applications executing during runtime. As shown herein, the user space 312 includes an application 316 placed in the user space 312 during runtime.

The kernel space 314, on the other hand, is that portion of the operating system 310 where kernel programs run to manage individual user processes within the user space 312 and prevent them from interfering with each other through various operations, such as thread scheduling, interrupt and exception handling, low-level processor synchronization, and recovery after power failure. The kernel programs are generally implemented across various OS stack layers, such as a file system layer 318, volume manager layer 320, I/O subsystem layer 322, and interface driver layer 324.

The file system layer 318 stores and organizes computer files and the data stored in these files for easy access and fast retrieval. The volume manager layer 320 includes a volume manager to manage disk drives, disk drive partitions, and other similar devices. The I/O subsystem layer 322 is responsible for the handling of I/O commands and includes disk drivers, which are software that facilitate a disk drive to interact with the operating system 310. The interface driver layer 324 handles the I/O commands received from the I/O subsystem 322 and enables hardware devices to interact with the operating system 310 with the help of device drivers. The operations of the file system layer 318, the volume manager layer 320, the I/O subsystem layer 322, and the interface driver layer 324 are well known in the art.

In an embodiment, the operating system 310 includes the classification module 326 having the classification search module 328 and the mapping module 330, which are used to classify an application command with a classification value. The classification search module 328 can interact with any of the higher level layers, such as the I/O subsystem layer 322 or the file system layer 318 or the volume manager layer 320, in the kernel space 314. In one embodiment, the classification search module 328 is located in the disk driver included in the I/O subsystem layer 322. The mapping module 330 can be located in the user space 312 of the operating system 310. The operating system 310 further includes a mapping database 332 included in the user space 312.

At the time of execution, the application 316 is loaded in the user space 312 of the operating system 310, where the application 316 generates an application command for performing an operation. Generally, the application command traverses through the file system layer 318 and is classified at the volume manager layer 320 using various workload management tools and techniques, such as Windows system resource manager and HP-UX process resource manager (PRM). These workload management tools and techniques manage system resources, such as CPU resources, memory, and disk bandwidth allocated to a workload, for example, application 316.

Typically, the application command is classified to include at least one classification parameter such as a Group ID that identifies the application 316 generating the application command. For example, in case of HP-UX operating system, the application command includes a PRM group ID. The classification parameter is used to deliver QoS within the host device 302.

The application command carrying the classification parameter may reach the I/O subsystem layer 322 from different routes depending on programming of the application 316. The application command from the application 316 can be routed through the file system layer 318 and the volume manager layer 320, or from the file system layer 318 bypassing the volume manager layer 320, or directly from the application 316 to the I/O subsystem layer 322.

In an implementation, upon receiving the application command, the disk driver in the I/O subsystem layer 322 invokes the classification search module 328 to fetch a classification value corresponding to the classification parameter. The classification parameter can include, for example, the Group ID that is included in the application command. The classification search module 328 determines a classification value corresponding to the classification parameter from a mapping table. The mapping table is stored and updated in the mapping database 332, from where the mapping table is fed to the classification search module 328 by the mapping module 330. The mapping module 330 creates, updates, and communicates the mapping table to the classification search module 328. In order to create the mapping table, the mapping module 330 is provided the mapping information by the management module 112, which includes QoS policies and QoS level descriptors, as described in the description of FIG. 1 and FIG. 2.

The classification search module 328 passes the determined classification value to the disk driver, which caches the classification value in an associated cache memory (not shown in the figure). Caching of the classification value facilitates quick retrieval of the classification value for another application command, which has a similar classification parameter. Any change in the classification value can be detected through a variety of in-kernel notification mechanisms known in the art. Based on such detection, the disk driver invokes the classification search module 328 to determine a modified classification value from the mapping table and to deliver the modified classification value to the disk driver. In order to notify and provide a modified classification value to the classification search module 328, the mapping module 330 dynamically renders the mapping table with a modified classification value corresponding to the classification parameter to the classification search module 328.

The disk driver passes the classification value along with the application command to the interface driver layer 324, where the included device driver inserts or attaches the classification value in the application command. This classification value acts as second classification information for the application command. The classification value can be sent along with the application command to the target device 104 from the host device 102-1 through the interface(s) 306, such as a host adaptor. The classification value in the application command can be used in a variety of ways at the host device 302 or at the target device 104. For example, the classification value can be used to deliver the desired QoS to the host device 302 by the target device 104 over the networks 106 as mentioned previously in the description of FIG. 1 and FIG. 2.

Though the above description is provided with reference to interactions between the classification search module 328 and the disk driver in the I/O subsystem layer 322, it will be understood that the classification search module 328 may interact with other layers as well as mentioned earlier. Further, as discussed, the classification value provided by the classification search module 328 can be, for example, a tag value or a virtual port number such as a V-port or an NPIV number, or both. This is further illustrated below with reference to exemplary mapping tables.

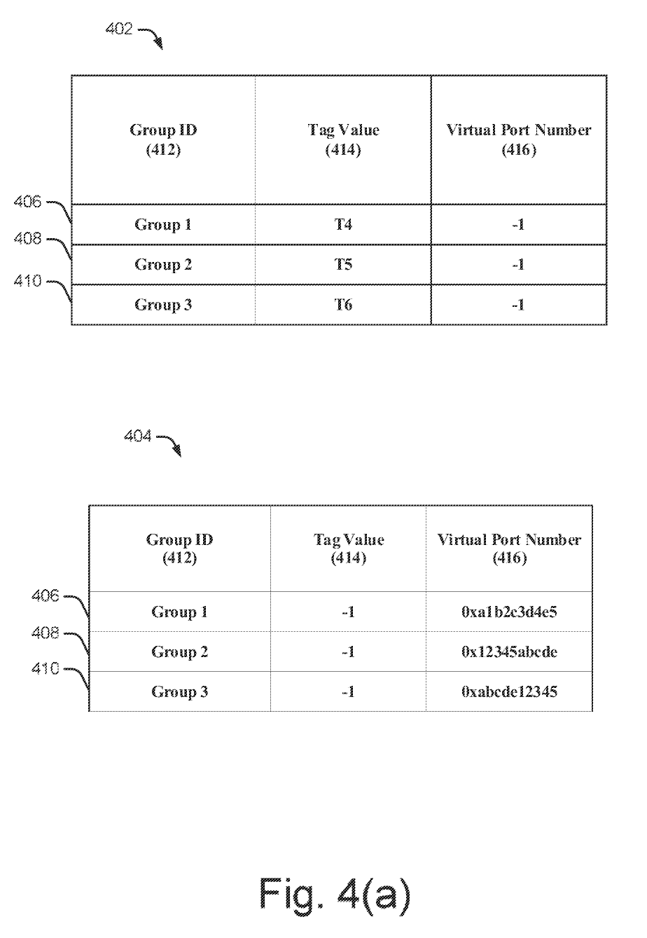

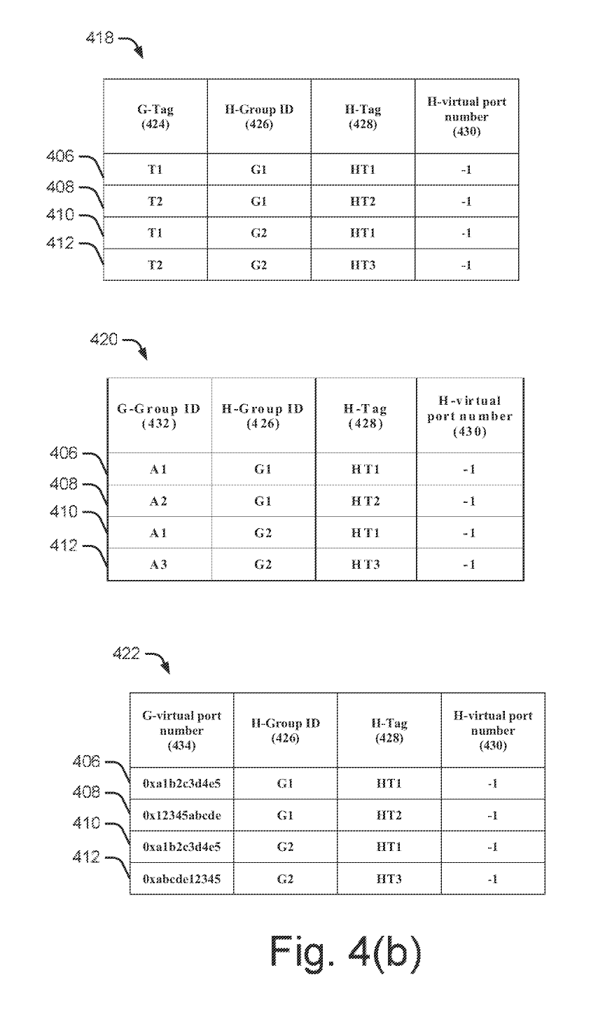

FIG. 4(a) illustrates exemplary mapping tables used for classification of the application commands in accordance with one embodiment of the present invention. A table 402 represents mapping of application commands with tag values based on group ids, while a table 404 represents mapping of application commands with virtual port number based on group ids. The tables 402 and 404 illustrate mapping tables for three application commands, referred to as a first, a second and a third application command, which correspond to rows 406, 408 and 410. Such mapping tables can be used for assigning classification values by an OS of a host device such as the OS 310 of the host device 302 or guest OS 204 of the host device 202.

As illustrated in table 402, in one implementation, the first, second and third commands may be allotted a tag value 414 using their respective Group ID 412 as the classification parameter. For example, in case of HP-UX operating system, tag values 414 can be mapped based on a process resource manager (PRM) group ID used as a classification parameter for each of the application commands. In one implementation, as shown in the row 406, the first command belonging to Group 1 is assigned a tag value T4. Similarly, as shown in rows 408 and 410, the second command belonging to Group 2 and the third command belonging to Group 3 can be assigned tag values T5 and T6, respectively. Since these commands are mapped to tag values, the virtual port number entry for all the commands is ‘−1’, representing a null value, as shown in the rows 406, 408, and 410.

As illustrated in table 404, in another implementation, the classification values may be allotted in the form of a virtual port number 416, such as NPIV values, based on the Group ID 412. For example, as shown in the row 406, the first command belonging to Group 1 is assigned a virtual port number 0xa1b2c3d4e5. Similarly, the second application command can be mapped to a new virtual port number 0x12345abcde and the third command can be mapped to a new virtual port number 0xabcde12345. The tag value 412 is marked as ‘−1’, representing a null value for the three application commands, as no tag value is assigned to the first, second, and third application commands according to the mapping table 404.

It will be understood that the tables 402 and 404 are not limited to the entries shown. Such tables can be extended to include more entries and similar tables can be created based on classification parameters apart from Group IDs as well.

FIG. 4(b) illustrates exemplary H-mapping tables for classification of application commands in a virtual environment in accordance with one embodiment of the present invention. These mapping tables can be used, for example, by the hypervisor 214 of the host device 202 to assign classification values, such as a H-tag value or a H-virtual port virtual port number, to application commands that have been classified by the guest OSs 204.

In an implementation, the hypervisor 214 receives the previously classified application commands that have been assigned G-group IDs and either a G-tag value or a G-virtual port number by the guest OS 204. The classification value assigned by the guest OS can be referred to as a previous classification value. Further, the hypervisor 214 assigns a classification value also referred to as H-classification value based on a combination of classification parameters, such as H-group ID, G-group ID, G-tag value and G-virtual port number.

For example, as shown in table 418, application commands corresponding to rows 406, 408 and 410 may be assigned G-tag values 424 by the guest OS 204. Further, the hypervisor 214 may assign H-group IDs 426 based on the guest OS issuing the application command. Based on the H-group IDs 426 and the G-tag values 424, the hypervisor can assign a new H-tag value 428, which can be used to prioritize the application commands at the target device.

This can be further illustrated using the following example as shown in table 418. Consider three applications X, Y and Z running on two guest OSs that issue application commands. The two guest OSs may be assigned H-group IDs G1 and G2 by the hypervisor 214, and are referred to as G1 and G2. Further, consider a case where the guest OS G1 provides a tag T1 to application commands of application X and a tag T2 to application commands of application Y. Similarly, the guest OS G2 provides a tag T1 to application commands of application X and a tag T2 to application commands of application Z.

The hypervisor 214 can then re-map the tags as shown in rows 406, 408, 410 and 412. Thus, the hypervisor 214 can provide H-tag HT1 to application commands of application X running on both G1 and G2, H-tag HT2 to application commands of application Y running on G1 and H-tag HT3 to application commands of application Z running on G2. The H-tags can then be sued at the target device to prioritize the application commands.

In another implementation, assignment of H-tag values 428 can be assigned based on H-group ID and G-group ID as shown in table 420. In yet another implementation, H-tag values 428 can be assigned based on H-group ID and G-virtual port number as shown in table 422.

In the implementations illustrated in tables 418, 420 and 422, the H-virtual port numbers 430 are shown as −1 to represent a null value. However, as will be understood, the hypervisor 214 can also use H-virtual port numbers 430 as a classification value instead of H-tag values 428.

Thus the hypervisor 214 can associate classification values, such as H-tag values 428, based on a combinational mapping of tag values and the virtual port numbers of the virtual ports associated with the guest operating systems 204.

For assignment of the classification values, the management module 112 can manage the mapping at both H-classification module 218 and G-classification module 206. For example, the management module 112 may direct the H-classification module 218 to provide an identity mapping of the G-tag values assigned by the G-classification module 206. In another case, the management module 112 may choose sequential tag assignments in the G-classification modules 206 and re-map these values to different ranges in the H-classification module 218. For example, if the G-classification module provides integer G-tag values, such as 1, 2, 3 . . . , the H-classification module 218 can change the G-tag values by adding an integer offset to them.

Further, it will be understood that the H-classification module 218 can assign both H-tag value and H-virtual port number for classification of the application commands. For example, the management module 112 may choose to have a H-tag value associated with an application command and also route it through a particular V-port. Thus, the H-mapping tables in this case would include both H-tag values and H-virtual port numbers.

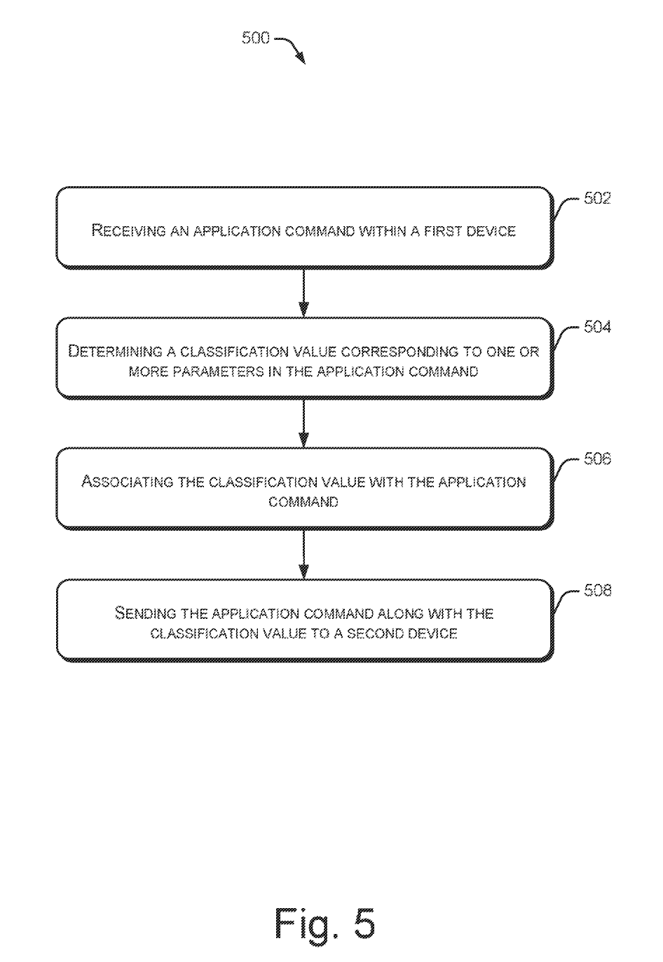

FIG. 5 illustrates an exemplary method for the classification of the application command, according to an embodiment of the present invention. These exemplary methods may be described in the general context of computer executable instructions. Generally, computer executable instructions can include routines, programs, objects, components, data structures, procedures, modules, functions, and the like that perform particular functions or implement particular abstract data types. The computer executable instructions can be stored on a computer readable medium and can be loaded or embedded in an appropriate device for execution.

The order in which the method is described is not intended to be construed as a limitation, and any number of the described method blocks can be combined in any order to implement the method, or an alternate method. Additionally, individual blocks may be deleted from the method without departing from the spirit and scope of the invention described herein. Furthermore, the method can be implemented in any suitable hardware, software, firmware, or combination thereof.

At block 502, in order to perform an operation across the networks 106 at a target device 104, an application 316 located in the user space 312 of the operating system 310 generates an application command during execution in a first device, such as the host device 302. The generated application command can be received at the kernel space 314 of the operating system 310. In an embodiment, the operating system 310 includes the classification module 326 having the classification search module 328 and the mapping module 330, in which the classification search module 328 may receive the application command through an appropriate OS stack layer.

At block 504, a classification value can be determined using a classification search module 328 based on one or more parameters associated with the application command. The application command can be handled by variety of workload management tools, such as the process resource manager (PRM) within the kernel space 314 to attach a classification parameter with the command, such that the parameter can be used to identify the application 316. In an embodiment, at the I/O subsystem layer 322 in the kernel space 314, the disk driver layer invokes the classification search module 328 to retrieve a classification value corresponding to one or more classification parameters included in the application command. For example, the disk driver layer can invoke the classification search module 328 to fetch a classification value corresponding to the Group ID associated with the application command. Accordingly, the disk driver layer may send the classification parameter to the classification search module 328.

At block 506, the classification value is associated with the application command. The classification search module 328 looks-up in a mapping table to provide the classification value to the disk driver layer in the I/O subsystem layer 322 based on the received classification parameter. The mapping table is created and updated by the mapping module 330 based on an interaction with the management module 112. The mapping module 330 feeds the mapping table to the classification search module 328, which determines the classification value. The classification search module 328 sends the determined classification value to the I/O subsystem layer 322, which receives the classification value for the application command. The I/O subsystem 322 caches the classification value for future use with an application command having a similar classification parameter.

At block 508, the I/O subsystem layer 322 sends the received classification value along with the application command to the interface driver layer 324 where the classification value is inserted into data payload of the application command to send to the interface(s) 306, such as a host adaptor. The application command associated with the classification value can be sent to a second device, such as the target device 104, over the networks 106-1 and 106-2. The classification value can be thus used to prioritize processing of the application command outside the host device 302. In an implementation, the classification value can be used at the target device 104 to deliver an application level QoS to the host device 302.

Although embodiments for classification of application commands have been described in language specific to structural features and/or methods, it is to be understood that the invention are not necessarily limited to the specific features or methods described. Rather, the specific features and methods are disclosed as exemplary implementations for the classification of application commands.

I/We claim:

1. A method comprising:
receiving an application command associated with a classification parameter, wherein the application command is generated by an application in a first device;
determining a classification value based on the classification parameter;
associating the classification value with the application command; and
sending the application command and the classification value to a second device for processing.

2. The method as claimed in claim 1, further comprising storing the classification value in the first device for subsequent retrieval based on the classification parameter.

3. The method as claimed in claim 1, further comprising prioritizing the application command based on the classification value at the second device.

4. The method as claimed in claim 1, wherein the classification value is determined based on the classification parameter and a previous classification value assigned to the application command.

5. The method as claimed in claim 4, further comprising assigning the previous classification value in a guest operating system environment based on a guest classification parameter.

6. A system comprising:
a host device comprising:
an application that generates a command to be processed by a target device; and
a classification module configured to provide a classification value for association with the command, wherein the classification value is based on at least one classification parameter associated with the command; and
a console having a management module configured to provide a mapping table to the host device, wherein the mapping table includes a mapping of the classification value and the at least one classification parameter.

7. The system as claimed in claim 6, wherein the management module provides a priority mapping table to the target device for prioritizing an access to a resource based on the classification value.

8. The system as claimed in claim 7, wherein the access to the resource includes access to one or more of storage resources, network resources, and processor resources.

9. The system as claimed in claim 6, wherein the classification module further comprises a mapping module configured to receive the mapping table from the management module.

10. A device comprising:
a processor; and
a memory coupled to the processor, wherein the memory comprises:
a classification module comprising:
a classification search module configured to determine a classification value for an application command based on at least one classification parameter associated with the application command, wherein the classification value is determined from a mapping table; and
a mapping module configured to provide the mapping table to the classification search module.

11. The device as claimed in claim 10, wherein the classification search module is located in a kernel space of an operating system and the mapping module is located in a user space of an operating system.

12. The device as claimed in claim 10, wherein the mapping module interacts with a management module to create and update the mapping table.

13. The device as claimed in claim 10, wherein the at least one classification parameter is a group ID.

14. The device as claimed in claim 10, wherein the at least one classification parameter is a group ID and a previous classification value associated with the application command.

15. The device as claimed in claim 10, wherein the classification value is selected from one or more of a tag value and a virtual port number.
